(19) United States
(12) Patent Application Publication
(10) Pub. No.: US 2026/0008624 A1
(43) Pub. Date: Jan. 8, 2026

(54) Conveyor System with Spiral Conveyor

(71) Applicant: Klotzki Maschinenbau GmbH, Mintraching (DE)

(72) Inventor: Arif Demirci, Mintraching (DE)

(73) Assignee: Klotzki Maschinenbau GmbH, Mintraching (DE)

(21) Appl. No.: 19/248,095

(22) Filed: Jun. 24, 2025

(30) Foreign Application Priority Data
Jul. 2, 2024 (DE) 10 2024 118 727.1

(51) Int. Cl. B65G 21/18; B65G 43/10

(52) U.S. Cl. CPC B65G 21/18; B65G 43/10; B65G 2201/0235; B65G 2203/0233; B65G 2203/0241; B65G 2203/042; B65G 2207/44

(57) ABSTRACT

A conveyor system for conveying containers includes a first transport section encircling a first machine axis in a helical manner and a second transport section encircling a second machine axis in a helical manner. A transfer section extends between the first transport section and the second transport section. At least one first driver is operatively connectable to containers in the first transport section. At least one second driver is operatively connectable to containers in the second transport section. The at least one first driver is driveable by means of a first drive for conveying containers along the first transport section. The at least one second driver is driveable by means of a second drive for conveying containers along the second transport section. The first drive and the second drive can be operated independently of each other.

### CROSS-REFERENCE TO RELATED APPLICATION

This application claims the benefit of German Patent Application No. DE 10 2024 118 727.1, filed Jul. 2, 2024, the disclosure of which is hereby incorporated by reference herein.

### BACKGROUND OF THE INVENTION

### Field of the Invention

The invention relates to a conveyor system with a spiral conveyor for conveying containers and with at least two sensor devices.

### Description of Related Art

Spiral conveyors are known in the prior art in various designs. For example, a spiral conveyor for containers in the form of transport crates is known from EP 2 279 803 A1, by means of which transport crates are conveyed along a transport section encircling a machine axis helically from a container inlet to a container outlet. The container inlet is vertically spaced apart from the container outlet so that a height difference is bridged by the spiral conveyor between the container inlet and the container outlet.

Such spiral conveyors can be used, for example, in devices for cleaning containers. However, spiral conveyors are also used for other purposes, for example, in conveyor technology to bridge height differences between an inlet and an outlet. Such spiral conveyors are disclosed, for example, in DE 10 2019 129 962 A1, WO 2020/201 101 A1, and US 2022/0 227 585 A1.

If spiral conveyors are used to convey containers, it is necessary in many applications for a continuous conveyor flow of containers to be provided at the container outlet, in which successive containers are spaced at a previously determined distance from each other or touch each other directly one after the other. For example, this is a requirement in the construction of cleaning systems for containers, since the cleaned containers, in a processing step following the cleaning, are often filled in a precise position with beverage storage equipment. Such cleaned containers include, for example, cans or bottles.

However, the feeding of containers at the container inlet of such a spiral conveyor often does not take place reliably in a continuous conveyor flow in which the containers are spaced apart equidistant. Even in the course of conveying the containers through the spiral conveyor, the distance between adjacent containers is often not adaptable with known solutions and irregularities in the spacing present at the container inlet are also present at the container outlet.

In order to equalise the spacing of the containers in a system or to provide additional containers for other components of a system, the so-called linear storage technique is often used in which a linear storage device in which containers are stored is arranged parallel to a conveyor belt. The linear storage device is usually loaded or emptied by means of gripping devices. A fixed number of containers arranged one after the other, for example, 10 or 15 containers, is clamped by the gripping device in a tong-like manner and moved back and forth between the conveyor belt and the linear storage device. If a gap in the conveyor flow of the containers is to be filled, containers are removed from the linear storage device and placed on the conveyor belt. Conversely, if the conveyor flow of containers is too dense, containers are removed from the conveyor belt by means of the gripping device and stored in the linear storage device.

The provision of a linear storage device, which is discontinuously loaded by a gripping device, entails several disadvantages. A linear storage device increases the space requirement of a plant, for example, a wash tunnel for containers, particularly when the linear storage device is used in combination with a spiral conveyor. In addition, a linear storage device can only be loaded with containers discontinuously, wherein only a specified number of containers can be moved between the linear storage device and the corresponding conveyor belt, and as a result, such a system has low or limited flexibility. Due to the high mechanical outlay of such a system, which arises on account of the additional gripping device and the linear storage device that also have to be provided, the system is also costly and error prone.

Consequently, a device is needed that enables reliable, flexible, cost-effective buffering of containers that can be operated as continuously as possible and, in particular, reacts within a short response time.

### SUMMARY OF THE INVENTION

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The problem of the present invention is to provide a device which enables a reliable, flexible, cost-effective buffering of containers that can be operated as continuously as possible and reacts within a short response time. This problem is solved by the conveyor system according to claim 1. Further advantageous aspects, details, and embodiments of the invention emerge from the dependent claims, the description, and the drawings.

The embodiments of the present invention described herein provide a conveyor system comprising a spiral conveyor for conveying containers along a transport section extending between a container inlet arranged in an inlet plane and a container outlet arranged in an outlet plane. The transport section comprises at least: a first transport section encircling a first machine axis in a helical manner, wherein the first transport section has a first spiral diameter and the first transport section has a first end and a second end opposite the first end; a second transport section encircling a second machine axis in a helical manner, wherein the second transport section has a second spiral diameter and the second transport section has a first end and a second end opposite the first end, wherein the second machine axis is aligned essentially parallel with the first machine axis; a transfer section, wherein the transfer section extends between the first transport section and the second transport section; at least a first driver, wherein the first driver can be brought into operative connection with containers arranged on the first transport section; and at least a second driver, wherein the second driver can be brought into operative connection with containers arranged on the second transport section.

The first transport section has at least one inner container guide extending relative to the first machine axis and at least one outer container guide extending relative to the first machine axis. The second transport section has at least one inner container guide extending relative to the second machine axis and at least one outer container guide extending relative to the second machine axis. The first driver penetrates the first transport section between the respective container guides, and the second driver penetrates the second transport section between the respective container guides.

Moreover, the transport section also comprises at least one first drive for conveying containers along the first transport section, wherein the first driver is designed to be driveable by means of the first drive, and at least a second drive for conveying containers along the second transport section, wherein the second driver is designed to be driveable by means of the second drive. The first drive and the second drive can be operated independently of each other.

The conveyor system also comprises a first sensor device arranged in an area of the container inlet, wherein the first sensor device is designed to detect a number and a direction of movement of the containers passing the container inlet and to send an inlet signal, wherein the inlet signal represents the detected number and the detected direction of movement of the containers passing the container inlet. In addition, the conveyor system comprises a second sensor device arranged in an area of the container outlet, wherein the second sensor device is designed to detect a number and a direction of movement of the containers passing the container outlet and to send an outlet signal, wherein the outlet signal represents the detected number and the detected direction of movement of the containers passing the container outlet. Finally, the conveyor system comprises a control unit comprising a signal interface, wherein the first sensor device and the second sensor device are in signal connection with the signal interface, and the control unit is designed to control the first drive and the second drive independently of one another, based on the signal transmitted by the first sensor device and the second sensor device and based on a demand signal transmitted by a system control.

The spiral conveyor, of which by the conveyor system according to the invention is comprised, can be used for a wide range of shapes and sizes of container. For example, the containers to be conveyed can be shaped cuboid, in particular containers in the form of bundles, beverage crates, or tubs, and can be conveyed by means of the provided spiral conveyor. The containers conveyed by the spiral conveyor can also be foldable containers, such as are often used for the transport and storage of foodstuffs, in particular meat, fruits, vegetables, and baked goods. The containers can be containers for the storage and transport of foodstuffs such as meat, fruit, vegetables, and baked goods, particularly butcher's crates, and particularly crates of sizes E1, E2 and E3.

The arrangement of the inlet plane and the outlet plane can be selected according to the requirements for a spiral conveyor. In particular, the inlet plane can be aligned parallel to the outlet plane and be spaced equally far from the ground as the outlet plane. In this case, the inlet plane and the outlet plane are thus identical, which is preferable when the provided spiral conveyor replaces existing buffer solutions, for example, linear storage devices which are integrated into an assembly line or production line. However, the inlet plane and the outlet plane can also be oriented differently or arranged at different distances from the ground, for example, when the conveyed containers are intended to bridge a height difference when passing through the spiral conveyor.

The container inlet and the container outlet can be installed on any side surfaces or faces of a spiral conveyor. For example, the container inlet and the container outlet can be arranged on the same, adjacent, or opposite side faces.

For the transport of the containers through the first transport section, a first drive is provided which is designed to drive the first driver, which enters into operative connection with the containers as soon as the containers have passed the container inlet. The containers are thus moved along the first transport section up to the transfer section.

The second drive is designed to drive the second driver, which enters into operative connection with the containers along the second transport section, i.e. from the transfer section to the container outlet.

The first and the second drive can be operated or driven independently of each other, i.e. they can be operated at different times and/or with different speeds and/or with different forces or torques. In other words, the motion caused by the first drive can at least temporarily be mechanically decoupled from the motion caused by the second drive. For this purpose, a dedicated drive control system can be provided to control each drive.

The spiral conveyor of the conveyor system according to an embodiment of the invention comprises at least a first driver, wherein the first driver can be brought into operative connection with the containers that are arranged on the first transport section. The spiral conveyor also comprises at least a second driver, wherein the second driver can be brought into operative connection with the containers that are arranged on the second transport section. The first driver can be driven by means of the first drive and the second driver by means of the second drive independently of one another. Consequently, the containers in the first transport section can be conveyed by means of the first driver independently of the containers in the second transport section, wherein the containers in the second transport section can be conveyed by means of the second driver.

It is particularly easy to operate the first and second drivers in different directions of rotation. It is therefore not only possible to move the containers along the first transport section in a first direction around the first machine axis, but also in the opposite direction. Similarly, the containers can be moved along the second transport section in a first direction around the second machine axis, as well as in the opposite direction.

The drivers can preferably extend essentially parallel to the first and/or second machine axis. Preferably, the drivers extend essentially along the entire extension of the inner transport section and/or the outer transport section parallel to the machine axis. Thus, one driver can be used to convey a plurality of containers, which are each offset from one another by a turn of the transport section, i.e. located above one another or below one another when viewed from the side, and brought into operative connection simultaneously with the same driver and moved by the latter.

Thus, an efficient feed of a plurality of containers can be carried out by a single driver, wherein the position of the conveyed containers in the turns of the transport section can be precisely specified.

By providing a first drive and a second drive which can be operated independently of each other, the containers in operative connection with the first driver can be moved during the conveying process through the first transport section independently of the containers in the second transport section and vice versa.

Particular advantages of the conveyor system according to the present invention are that the first drive for conveying containers along the first transport section and the second drive for conveying containers along the second transport section can be operated independently of each other. Since the first driver is designed to be driveable by means of the first drive and the second driver is designed to be driveable by means of the second drive, the two drivers can be operated at different speeds as well as in different directions of rotation. The containers can thus be moved along the first and second transport sections along the respective machine axis in the same direction as well as in different directions. In addition, the first and second drivers can be easily operated in the same or opposite direction of rotation to one another.

It directly follows from this for the skilled person that the terms “inlet plane”, “container inlet”, “outlet plane” and “container outlet” represent terms merely selected for a simpler and clearer description of the invention. Both “container inlet” as well as “container outlet” can be used for the feeding of containers to the respective transport sections, as well as for the removal of the containers from the conveyor system. Depending on the direction of rotation of the corresponding driver, the container inlet can also act as a container outlet and vice versa. The container inlet can therefore also be arranged in the container outlet plane and the container outlet can also be located in the container inlet plane.

Due to the fact that the first and second drivers can be operated independently of each other in the same or opposite direction of rotation, it also follows that the container inlet and the container outlet can both function as container inlets at the same time. This is particularly advantageous when a large number of containers has to be fed in a short time to the spiral conveyor acting as a buffer.

Conversely, the container inlet and the container outlet can both function as container outlets at the same time. This is particularly advantageous when a large number of containers has to be removed in a short time from the spiral conveyor functioning as a buffer.

In addition to a spiral conveyor, the conveyor system according to an embodiment of the invention comprises at least a first sensor device arranged in the area of the container inlet and at least a second sensor device arranged in the area of the container outlet. The first sensor device is for detecting a number and a direction of movement of the containers passing through the container inlet and for sending a signal, wherein the signal represents the detected number and the detected direction of movement of the containers passing the container inlet. The second sensor device is for detecting a number and direction of movement of the containers passing the container outlet and for sending a signal, wherein the signal represents the detected number and the detected direction of movement of the containers passing the container outlet. Finally, the conveyor system comprises a control unit comprising a signal interface, wherein the first sensor device and the second sensor device are in signal connection with the signal interface and the control unit is designed to control the first drive and the second drive independently of each other, based on the signal transmitted by the first sensor device and the second sensor device and based on a demand signal transmitted by a system control.

The signals sent by the first and second sensor device to the signal interface can, for example, be analog signals, which indicate the number and direction of movement of the containers that pass the container inlet or the container outlet.

The conveyor system further comprises at least one control unit comprising a signal interface. The first and second sensor devices are in signal connection with the signal interface of the control unit. The control unit is designed to control the first drive and the second drive independently of each other based on the signal transmitted by the first and the second sensor device and based on a demand signal transmitted by a system control.

The conveyor system according to an embodiment of the invention combines a spiral conveyor, which comprises two spirally formed transport sections, two drivers penetrating the respective transport section and two independently operated drives of the drivers, with two sensor units arranged at the container inlet and/or the conveyor outlet, which are connected to a control unit via a signal interface. Since the two drivers can be driven independently of each other by means of the two drives and the two drivers can also be operated in different directions of rotation, the conveyor system can respond to demand requests with extreme flexibility and within a short response time.

If, for example, a fault is transmitted from any point on the production line to the control system, which requires an immediate stoppage of the supply of containers, the conveyor system can respond immediately by operating the two drivers in the same direction of rotation, in such a way that both the container inlet and the container outlet function as container inlets. In this way, containers in large numbers are immediately fed to the two transport sections at the same time and are buffered therein.

Conversely, the conveyor system can also respond by operating the two drivers in the same direction of rotation, in such a way that both the container inlet and the container outlet function as container outlets. In this way, containers in large numbers are immediately transferred from the conveyor system to the production line when a corresponding demand request is transmitted to the control unit.

In an embodiment of the invention, the first transport section and the second transport section encircle the respective machine axes spirally, i.e. the first transport section and the second transport section form a curve that winds around the lateral surface of an imaginary cylinder, the axis of rotation of which is the respective machine axis. The pitch of a transport section is the vertical distance around which the transport section winds around the machine axis when the transport section is completely rotated around the respective machine axis.

If the lateral surface area of the cylinder along which the transport section winds is unwound into a plane, the transport section forms a curve in this plane. The gradient that the transport section has in this plane is referred to as the gradient of the transport section. The first transport section and the second transport section preferably have a constant gradient, but individual sections of the spiral may also be steeper or flatter, for example if the spirals are subject to geometrical restrictions which are imposed by the installation site of a spiral conveyor and/or equipment which is installed on or near a spiral conveyor.

The first spiral diameter or the second spiral diameter corresponds to the diameter of the cylinder enclosed by the respective transport section.

The winding direction of the first transport section and the second transport section is selectable, in particular, the first and second transport sections can have the same winding direction, as a result of which the design and production of the transport sections are, for example, standardised and thus simplified. Alternatively, the first and second transport sections can have different winding directions.

The transport section is split by the transfer section into two elements, which are referred to as the “first” transport section and the “second” transport section. The designation “first” transport section and “second” transport section in the context of the present disclosure serves only to distinguish different elements of the transport section from each other, and in particular does not constitute any indication as to the order in which the containers pass through the transport sections.

For example, the spiral conveyor can be characterised by the fact that the first end of the first transport section is arranged at the container inlet and the second end of the second transport section is arranged at the container outlet, and the transfer section extends between the second end of the first transport section and the first end of the second transport section. In this configuration of the spiral conveyor, the containers conveyed by the spiral conveyor first pass the container inlet, transport then takes place along the first transport section, along the transfer section, and subsequently along the second transport section. Finally, the containers are made available at the container outlet for further transport.

In an alternative embodiment, however, the path that the containers travel when being conveyed through the spiral conveyor can, for example, lead from the container inlet along the second transport section, and along the first transport section via the transfer section, so that the containers can then be made available at the container outlet. In contrast with the previously mentioned configuration, in this inverse configuration of the spiral conveyor, the spiral conveyor is therefore characterised in that the first end of the second transport section is arranged at the container inlet and the second end of the first transport section is arranged at the container outlet and the transfer section extends between the second end of the second transport section and the first end of the first transport section.

Due to the freely selectable direction of rotation of the drivers, however, the containers do not have to go through the entire transport section. The containers can, for example, be taken from the production line, fed to the first transport section, and stored therein for buffering. By reversing the direction of rotation of the corresponding driver, these containers can be transferred again directly from the first transport section to the production line. The same applies to the second transport section.

The winding direction of the first transport section and the second transport section can also be freely configured. For example, the first transport section can have a right-hand winding direction, and the second transport section can have a left-hand winding direction, or vice versa. Also, with a corresponding configuration of the transfer section, both transport sections can have the same winding direction.

The first drive and the second drive can preferably be controlled in such a way that, in response to a demand signal from a system control, a continuous stream of containers is provided at the container outlet. For example, provision can be made such that the drives can be controlled in such a way that the transport section arranged between the transfer section and the container outlet is filled as far as possible with containers.

In a preferred embodiment, in addition to the first drive and the second drive, the spiral conveyor of the conveyor system according to the invention can have a third drive for conveying containers along the transfer section, which can further preferably be operated independently of the first drive and the second drive.

The specific design of the drives is freely selectable. More precisely, the design of each one of the drives can be selected individually, so that the first drive can be designed differently from the second drive. An optionally present third drive can also be designed differently from the other drives.

By operating the first and second drives independently, for example, the timing of containers between the container inlet and the container outlet can be changed and/or the flow of the containers arriving at the container inlet can be equalised. The drives can also be controlled independently of each other, in order to provide a continuous stream of buffered containers at the container outlet.

For this purpose, in a merely exemplary configuration of the transport section, containers can be conveyed along the first transport section by the first drive to the transfer section. Buffering of containers can take place in the transfer section, in particular the containers can be pushed or introduced by the first drive into the transfer section in such a way that they are arranged directly behind one another in the transfer section. In this arrangement, the containers can be transported to the container outlet by the second drive, which for example is only operated when sufficient containers are present in the transfer section, or when a signal of a system control requires the provision of containers at the container outlet.

The second transport section is preferable always completely filled with containers, so that a gap-free provision of the containers at the container outlet can take place. To fill empty spaces in the second transport section, containers can be pushed, for example, by the first drive through the transfer section into the second transport section.

The spiral conveyor of the conveyor system can preferably comprise a plurality of first and/or a plurality of second drivers, in particular the drivers can be distributed equidistant along the spiral circumference of the first transport section and/or along the spiral circumference of the second transport section. In a preferred embodiment, the distance between adjacent drivers can essentially correspond to the dimensions of the containers to be conveyed or be slightly larger than the dimensions of the containers to be conveyed, so that the containers conveyed in the first and/or second transport section are moved individually by a first or second driver in the spiral direction. For example, the spiral conveyor can comprise 6 first drivers uniformly distributed over the circumference and 12 second drivers uniformly distributed over the circumference, or vice versa.

As in the case just described, the drivers can enter directly into operative connection with the containers or they can comprise driver elements, in particular driver fingers, in order to enter into operative connection with the containers.

The first driver and/or the second driver can preferably each be formed on at least one, in particular at least two driver support elements opposite one another in the longitudinal direction of the machine axis and rotatable about the machine axis. The support of the drivers preferably takes place by means of the driver support elements, i.e. viewed from the side perspective of the respective machine axis, on both sides and outside the region along which the drivers enter into operative connection with containers.

A particularly stable guidance of the drivers is thus enabled and a uniform load distribution in the drivers results. Moreover, the occurring bending moments are reduced by the support on both sides compared to a one-sided support. In addition, tilting of the drivers is prevented and the durability of the spiral conveyor is improved because damage caused by material fatigue is reduced. In the case of an annular design of the drive support elements, moreover, there is good accessibility to the spiral interior, for example to arrange equipment therein for controlling the spiral conveyor and (measuring) instruments or other working devices.

The first transport section comprises at least one inner container guide extending relative to the first machine axis and at least one outer container guide extending relative to the first machine axis. The second transport section correspondingly comprises at least one inner container guide extending relative to the second machine axis and at least one outer container guide extending relative to the second machine axis. This has the advantage that a particularly precise guidance of the containers is possible due to the inner and outer container guides. Moreover, the spiral conveyor can be designed in such a way that the undersides of the containers are also accessible during the conveying process along the transport section. This makes it possible, for example, to wash and/or dry the containers from all sides, wherein water used for this purpose can drain downwards.

The first driver penetrates the first transport section between the respective container guides, and the second driver penetrates the second transport section between the respective container guides, which leads to a particularly simple structure of the spiral conveyor used as part of the conveyor system according to the invention.

In a preferred embodiment, the first machine axis is parallel-shifted, or parallel to and shifted, with respect to the second machine axis. In particular, the distance between the first machine axis and the second machine axis can be at least equal to a sum of half the first spiral diameter of the first transport section, i.e. the spiral radius of the first transport section, and half the second spiral diameter of the second transport section, i.e. the spiral radius of the second transport section.

In this embodiment, the first spiral transport section and the second spiral transport section can therefore be arranged next each other, which has the advantage of a particularly simple structure. The distance between the second end of the first transport section and the first end of the second transport section is bridged by the transfer section which, in this embodiment, can be designed rectilinearly for example and therefore particularly simply. At the same time, the spiral conveyor is space-saving due to the high handling capacity of the helically designed first and second transport sections, compared to known systems that operate only linearly.

In an alternative preferred embodiment, the first machine axis and the second machine axis can form a common machine axis. In this case, the first transport section and the second transport section have different spiral diameters, in particular the first transport section can have a first spiral diameter and the second transport section a second spiral diameter, wherein the first spiral diameter is smaller than the second spiral diameter, so that the first transport section and the second transport section are arranged offset from each other in a radial direction in relation to the common machine axis.

Consequently, either the first transport section or the second transport section can be arranged inside the respective other transport section. This creates a particularly space-saving design of the spiral conveyor.

For example, according to a preferred embodiment the first transport section can be designed as the inner transport section and the second transport section as the outer transport section. Consequently, the containers can first be conveyed in the inner, first transport section to the transfer section and then in the second, outer transport section from the transfer section to the container outlet.

In both cases, i.e. both in the case where the first machine axis is parallel-shifted, or parallel to and shifted, with respect to the second machine axis, as well as in the case where the first machine axis and the second machine axis form a common machine axis, any number of spiral conveyors can basically be used in combination in a conveyor system. In this way, the desired buffer effect is constantly increased. When a plurality of spiral conveyors are combined, the containers are transferred from one spiral conveyor to the next spiral conveyor via correspondingly designed transfer sections.

Likewise, the transport section of a single spiral conveyor can in principle comprise more elements than the above-mentioned first transport section, the above-mentioned second transport section, and the above-mentioned transfer section. For example, the transport section of the spiral conveyor can comprise a first transport section, a second transport section and a third transport section, each of which encircles an associated first, second, or third machine axis in a spiral manner. The transport sections can each be equipped with an associated first, second, or third drive and can be connected by means of correspondingly designed transfer sections.

In the case where the first machine axis and the second machine axis are designed in the form of a common machine axis, the outer container guide of the first transport section, i.e. the transport section with the smaller spiral diameter, can preferably correspond to the inner container guide of the second transport section, i.e. the transport section with the larger spiral diameter. The provision of a central, “split” container guide enables material savings, as a result of which the cost of a provided spiral conveyor is reduced.

On account of the geometrical conditions just explained, the containers cover a shorter distance when passing through the inner first transport section than when passing through the outer second transport section. Due to the greater length, more containers can be stored in the outer transport section than in the inner spiral, so that the buffering of the containers takes place closer to the container outlet. Consequently, the containers can be made available at the container outlet more quickly, i.e. with a shorter response time to a signal from a system control.

Also in the reverse case, i.e. when the second transport section is arranged internally with respect to the first transport section, i.e. in the case where the second spiral diameter is smaller than the first spiral diameter, a split container guide can be provided. In this case, the outer container guide of the second transport section corresponds to the inner container guide of the first transport section.

In a preferred embodiment, the transfer section extends at least partly in a radial direction in relation to the first machine axis and/or in relation to the second machine axis. In this case, the transfer section serves to bridge the difference in the spiral diameters between the smaller spiral diameter of the radially inner transport section relative to the machine axis and the larger spiral diameter of the radially outer transport section relative to the machine axis.

The transfer section is not necessarily curved around the first and/or second machine axis but can run linearly or be curved around a centre of curvature located elsewhere. In this design, the transfer section thus enables a space-saving transfer of the containers from the first to the second transport section or vice versa. At the same time, the transfer section creates an additional buffer effect between the first and second transport section and can, as will be explained in more detail below, bring about a reversal of the conveying direction of the containers between the transport sections by forming an approximately 180° curve for the containers.

The transfer section can preferably extend radially relative to the machine axis within a lateral surface area of a cylinder defined by the outer container guide of the second transport section, i.e. the transport section with the greater spiral diameter. In this case, the spiral conveyor is designed particularly space-savingly and can also be used in confined spaces, for example, in connection with a washing or filling system.

Accordingly, the containers first move, for example, on a spiral path along the smaller first spiral diameter of the first transport section, and then the containers are transferred along the transfer section to the spiral path of the second transport section, which has a larger second spiral diameter. The transfer section can be designed, for example, in the form of a simple baffle plate. Alternatively, at least a part of the transfer section can be designed in the form of a 180° curve.

In a preferred embodiment, the transfer section extends relative to the machine axis at least partially radially outside of a lateral surface of a cylinder defined by the outer container guide of the second transport section, i.e. the transport section with a larger spiral diameter. In this case, neither the first driver nor the second driver can be brought into operative connection along the transfer section with the containers to be conveyed.

Advantageously, the geometry of the transfer section can be designed very freely in this variant of embodiment, because the transfer section can largely run radially outside the first and second transport sections. In particular, it is not necessary for drivers to pass through the transfer section in the part of the transfer section that is arranged outside the outer transport section. In this respect, the transfer section does not have to be interrupted in this outer area, so that drivers can pass, as may be necessary, in the inner area of the transport sections.

Irrespective of the specific arrangement, the transfer section can be designed as a passive element, i.e. for example, as a sliding plate or chute along which the containers are not actively conveyed. However, when the transfer section is designed long or a conveyance of the containers is desired with precision and accurate timing, it can be preferable to provide a conveying element, for example a conveyor belt or a conveyor chain, on the transfer section, so that the containers can also be moved from the first to the second transport section driven actively by the conveying element in the area of the transfer section.

In a further preferred embodiment, the transfer section extends, relative to the first machine axis and/or second machine axis, spaced apart from the inlet plane and the outlet plane, and in particular positioned above the inlet plane and the outlet plane. It is also preferable that the transfer section can extend in a transfer plane parallel to, and in particular horizontal to, the inlet plane and outlet plane.

Consequently, the containers in this embodiment are conveyed, for example, along the first transport section from the inlet plane up to the transfer plane. The containers are then conveyed from the transfer plane down to the outlet plane. In this way, the available space is used efficiently to provide the longest possible transport section, and thus the largest possible buffer zone for storing the containers in the spiral conveyor.

In a preferred embodiment, the first transport section and the second transport section are orientated such that the transfer section is arranged between the second end of the first transport section and the first end of the second transport section such that the direction of movement of the containers that can be arranged on the transport section along the first transport section relative to a longitudinal direction of the first machine axis is opposite to the direction of movement of the containers that can be arranged on the transport section along the second transport section.

For example, the containers can first be conveyed above, i.e. upwards, and then below, i.e. downwards, or vice versa. Thus, in the case where the containers are not to overcome a height difference, the space available for the spiral conveyor is utilised particularly efficiently and comprehensive buffering of the containers is provided.

The first machine axis and/or the second machine axis or the common machine axis is preferably perpendicular to the inlet plane and/or the outlet plane. A spiral conveyor designed in this way can be integrated particularly well into an existing production line, in particular the interfaces to conveyor belts, which convey containers to the container inlet and receive them from the container outlet, which can, for example, be retained.

The first transport section and the second transport section preferably have the same or equivalent spiral gradients. Cooperate effects of the transport sections can thus be particularly easily utilised. For example, common guide rails and/or a common holder in the machine frame of the spiral conveyor can be provided.

The control unit provided according to the invention can for example be designed to control the first drive and the second drive in such a way that the containers to be conveyed at the container outlet are provided with a constant division.

The conveyor system can preferably comprise at least a third sensor device, which is designed to redundantly check, or verify, the number and direction of movement of the containers detected by the first sensor device and/or the second sensor device. The third sensor device can also preferably be arranged in an area of the transfer section.

By means of the redundant provision of the signal indicating the detected number and direction of movement of the containers, the third sensor device makes it possible to detect errors in the operation of the conveyor system, such as for example wedging of the containers during transport through the first and/or second transport section, and thus improve reliability in the operation of a conveyor system.

The first and/or the second and/or the third sensor device can for example be designed as light barriers, which are designed to detect the passage of containers and to increment a counting unit based thereon. Alternatively, the detection of a container and detection of the direction of movement of the container can be transmitted as a signal to the control unit, which can be designed to count the containers.

Due to the described design and arrangement of the sensor devices, balancing of the containers present in the spiral conveyor can be carried out at any time. Developments, advantages and possible applications of the invention also emerge from the following description of examples of embodiment and from the figures. All the described and/or illustratively represented features are in themselves or in any combination basically subject-matter of the invention, irrespective of their combination in a claim or in a combination in a claim dependent therefrom.

### BRIEF DESCRIPTION OF THE DRAWINGS

Embodiments of the invention will be explained in greater detail below on the basis of examples of embodiments in combination with the attached drawing figures described herein:

FIG. 1 is a schematic representation showing a perspective view of a first embodiment of a conveyor system;

FIG. 2 is a schematic representation showing a side view of the conveyor system according to FIG. 1;

FIG. 3 is a schematic representation showing a plan view of the conveyor system according to FIG. 1;

FIG. 4 is a schematic representation showing a side view of a second embodiment of a conveyor system;

FIG. 5 is a schematic representation showing a plan view of the conveyor system according to FIG. 4; and

FIG. 6 is a schematic representation showing a perspective view of a third embodiment of a conveyor system.

The drawings do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description references the accompanying drawing figures that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Identical reference numbers are used in the figures for the same or identically functioning elements of the invention. Furthermore, for the sake of clarity, only reference numbers are shown in the individual figures that are required for the description of the respective figure. The invention is represented in the figures merely as a schematic view to explain the mode of operation. In particular, the representations in the figures serve only to explain the basic principle of the invention. For reasons of clarity, other components of the device have not been shown.

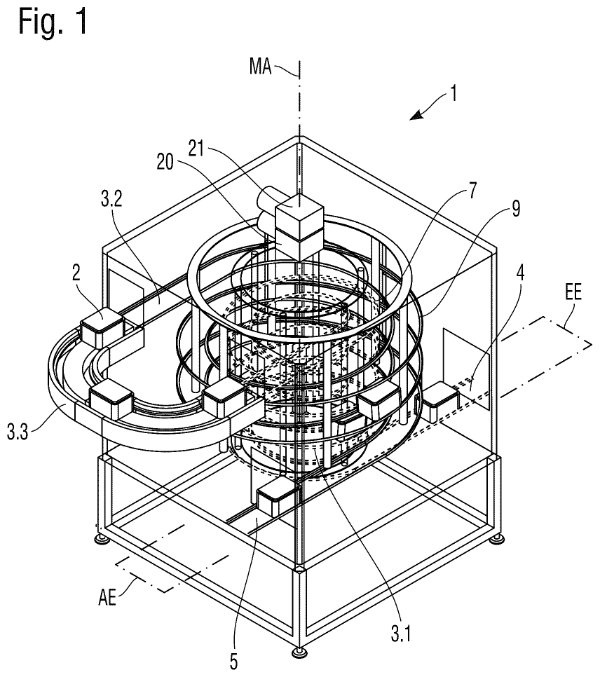

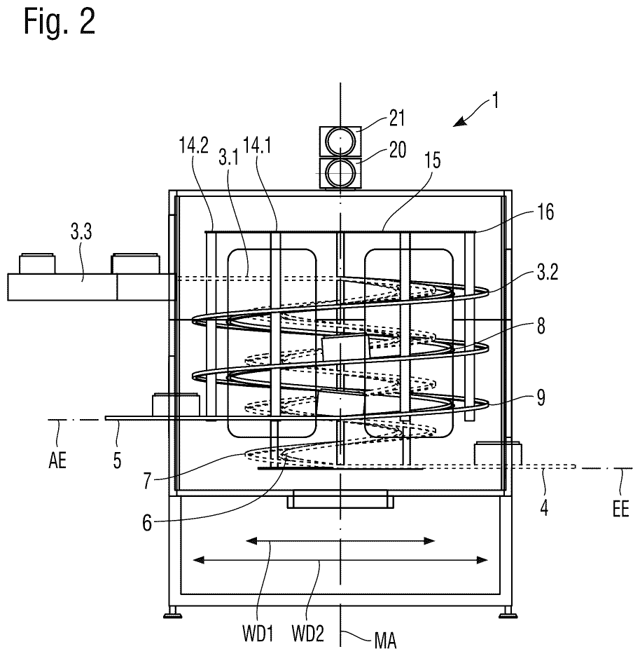

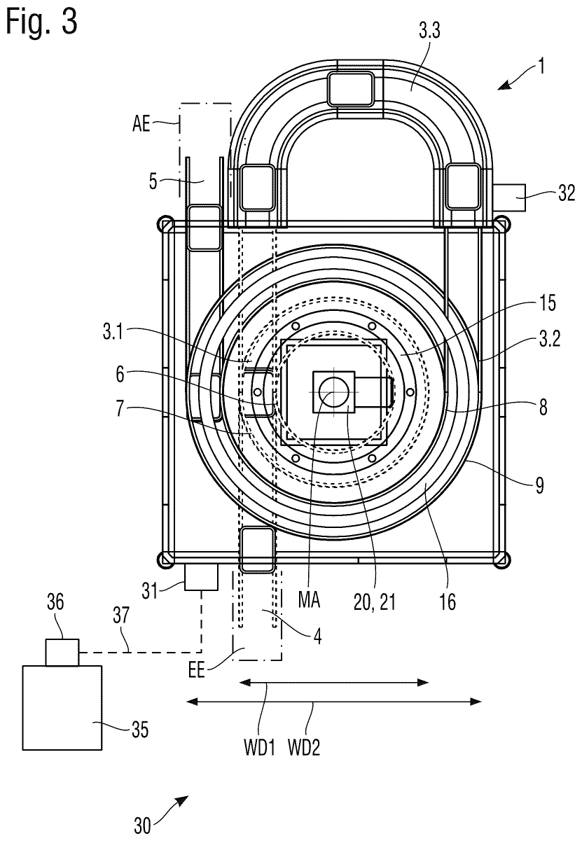

FIGS. 1 to 3 show a schematic representation of a first embodiment of a conveyor system with a spiral conveyor 1. FIG. 1 shows a perspective view. FIG. 2 shows a side view, and FIG. 3 a plan view of spiral conveyor 1 used in the conveyor system.

Spiral conveyor 1 is used to convey and store containers 2. Containers 2 are cuboid in shape, and can, in particular, be constituted as transport crates or beverage crates, such as are often used for the transport and storage of foodstuffs or beverage containers.

Containers 2 are fed to spiral conveyor 1 at a container inlet 4. The supply of containers 2 can take place, for example, via a transport element which is arranged in front of container inlet 4. The transport element can, for example, be designed as a conveyor belt. Container inlet 4 is arranged in an inlet plane EE, which in the embodiment shown extends essentially horizontally, i.e. essentially parallel to a set-up area of spiral conveyor 1.

The transport section extends away from container inlet 4 and comprises a first transport section 3.1, a second transport section 3.2 and a transfer section 3.3. In the embodiment shown in FIGS. 1 to 3, first transport section 3.1 and second transport section 3.2 wind spirally or helically around a common machine axis MA. In the embodiment represented, machine axis MA extends essentially perpendicular to inlet plane EE, i.e. in the vertical direction.

First transport section 3.1 has a first spiral diameter WD1. Second transport section 3.2 has a second spiral diameter WD2. Second spiral diameter WD2 is larger than first spiral diameter WD1, so that second transport section 3.2 is arranged external to first transport section 3.1 in the radial direction. In other words, second transport section 3.2 at least partially encircles first transport section 3.1.

First transport section 3.1 has a first end and a second end. Second transport section 3.2 has a first end and a second end. The first end of first transport section 3.1 is arranged at container inlet 4, so that containers 2, which are fed to spiral conveyor 1 via container inlet 4, pass the first end of first transport section 3.1 and enter into first transport section 3.1.

A container outlet 5 is arranged in an outlet plane AE on the side of spiral conveyor 1 opposite container inlet 4. Containers 2, which are conveyed and stored in spiral conveyor 1, are made available via conveyer outlet 5 at subsequent stations of a treatment line or production line. Outside of the spiral conveyor 1, a transport element, in particular a conveyor belt, can be provided for this purpose adjacent to container outlet 5, which is suitable for the removal of the provided containers.

Although container inlet 4 and container outlet 5 are arranged opposite each other in spiral conveyor 1 in the embodiment shown, a different arrangement of container inlet 4 and container outlet 5 can, however, also be provided. For example, container inlet 4 and container outlet 5 can be arranged on the same side face of spiral conveyor 1 or on adjacent side faces. In addition, as explained in detail herein, container inlet 4 can also serve as a container outlet and container outlet 5 can also function as a container inlet.

The arrangement of inlet plane EE relative to outlet plane AE can essentially be freely selected and depends, in particular, on whether containers 2 conveyed in spiral conveyor 1 are conveyed to bridge a height difference or whether containers 2 are to be provided from the same plane as the plane to which they are transferred onto spiral conveyor 1. In the variant of an embodiment shown, inlet plane EE and outlet plane AE are spaced a vertical distance apart, so that outlet plane AE is arranged higher compared to the inlet plane EE.

The second end of second transport section 3.2 is arranged directly adjacent to container outlet 5, so that containers 2 are provided at container outlet 5 after being conveyed through second transport section 3.2.

The transfer section 3.3 is provided between first transport section 3.1 and second transport section 3.2. Transfer section 3.3 connects the second end of first transport section 3.1 with the first end of second transport section 3.2. Transfer section 3.3 essentially extends in a plane parallel to inlet plane EE and to outlet plane AE.

Both first transport section 3.1 and second transport section 3.2 comprise respective container guides 6, 7, 8, and 9, which limit the path of containers 2 and direct the movement of containers 2 when containers 2 are moving along first transport section 3.1 and/or along second transport section 3.2. First transport section 3.1 comprises an inner container guide 6, which limits the mobility of containers 2 in a radial direction inwards. Outer container guide 7 of first transport section 3.1 limits the mobility of the containers 2 in a radial direction outwards, so that containers 2 can only be moved in the circumferential direction of the spiral of first transport section 3.1. In this respect, second transport section 3.2 has a similar structure to first transport section 3.1. In particular, second transport section 3.2 comprises an inner container guide 8 and an outer container guide 9.

In an embodiment, transfer section 3.3 extends at least partially outside the lateral surface of the cylinder, which is defined by outer container guide 9 of second transport section 3.2. A simple structure of spiral conveyor 1 is thus implemented. In particular, there is a great deal of freedom in the design of transfer section 3.3, for example, because the length of transfer section 3.3 can be adjusted without varying first spiral diameter WD1 of first transport section 3.1 or second spiral diameter WD2 of second transport section 3.2. Transfer section 3.3 has an essentially arc-shaped course, so that containers 2 exiting from the second end of first transport section 3.1, after the transport along the transfer section 3.3, are fed in the opposite direction of movement at the first end of second transport section 3.2.

Viewed in a plan view, containers 2 move along first transport section 3.1 in a clockwise direction, and containers 2 spiral upwards when moving in the clockwise direction. Along second transport section 3.2, containers 2, viewed in a plan view, can also move in a clockwise direction, and containers 2 spiral downwards when moving in the clockwise direction.

Particularly advantageous with this arrangement of first transport section 3.1, transfer section 3.3, and second transport section 3.2, is that the direction of movement of containers 2 through spiral conveyor 1 can easily be reversed, for example, if a reversing operation has to be carried out due to a fault in a system. For example, containers 2, which are fed via container outlet 5, can be conveyed along second transport section 3.2 in a counterclockwise direction, viewed in a plan view, upwards to transfer section 3.3. From transfer section 3.3, containers 2 can then be conveyed along first transport section 3.1 in a counterclockwise direction, viewed in a plan view, downwards to container inlet 4.

In order to move containers 2 along first transport section 3.1 and along second transport section 3.2, spiral conveyor 1 comprises a first drive 20 and a second drive 21. First drive 20 can be controlled and operated independently of second drive 21, so that the movement of containers 2 in first transport section 3.1 can be specified independently of the movement of containers 2 in second transport section 3.2.

First drive 20 can, in principle, be designed in any manner as long as containers 2 can be moved along first transport section 3.1 by means of first drive 20, whereby first drive 20 drives first drivers 14.1, which then enter into operative connection with containers 2. Likewise, second drive 21 can, in principle, be designed in any manner as long as second drivers 14.2 are driven by means of second drive 21, which then enter into operative connection with containers 2 and move containers 2 along second transport section 3.2.

As can best be seen from FIG. 2, first drivers 14.1 and second drivers 14.2 extend from a respective driver support element 15 and 16, essentially in the longitudinal direction of machine axis MA, i.e. parallel to machine axis MA. Drivers 14.1 and 14.2 penetrate respective transport sections 3.1 and 3.2 between respective inner container guide 6 and 8 and respective outer container guide 7 and 9.

First drivers 14.1 and second drivers 14.2 are designed rotatable around common machine axis MA. For example, driver support elements 15 and 16, from which first drivers 14.1 and second drivers 14.2 project, respectively, can be supported on spiral conveyor 1 in a rotatable manner around machine axis MA. Consequently, first drivers 14.1 and second drivers 14.2 can be moved in the circumferential direction of first transport section 3.1 and second transport section 3.2, respectively, when respective drive support elements 15 and 16 are set in rotation.

If driver support elements 15 and 16 are set in rotation, respective drivers 14.1 and 14.2 enter into active connection with containers 2, and containers 2 are moved in the circumferential direction of the spiral, for example, containers 2 are moved by being pushed or pulled by drivers 14.1 or 14.2. Due to the gradient of the spiral, not only is a movement of containers 2 in the circumferential direction caused, but containers 2 move up or down at the same time, depending on how the windings of respective transport sections 3.1 and 3.2 are oriented and in which direction containers 2 are moving along respective transport sections 3.1 and 3.2.

As can be seen in particular from FIG. 2, driver support elements 15 and 16 can be arranged on both sides of respective drivers 14.1 and 14.2 in the longitudinal direction of machine axis MA, i.e. above and below. In order to improve the clarity of the figure, only driver support elements 15 of first drivers 14.1 are shown on both sides of first drivers 14.1. However, the same can also be implemented for drivers 14.2 without any problems.

For example, first drive 20 and/or second drive 21 can be designed as electric motors and comprise a mechanical connection to associated respective driver support elements 15 and 16, so that the latter can be set in rotation by the electric motors. Electric motors have the advantage that they can be easily switched on and off and can easily be controlled and regulated in their movement by means of a control unit.

Transfer section 3.3 can be designed as a passive element, i.e. such as in a case not suitable to set containers 2 in motion therein. Rather, containers 2 can be pushed by first drive 20 and/or second drive 21 into transfer section line 3.3 with the aid of respective first or second drivers 14.1 and 14.2. If containers 2 have sufficient kinetic and/or potential energy, containers 2 can slide through transfer section 3.3 until they are in operative connection with respective other driver 14.2 and 14.1. If the kinetic and/or potential energy of containers 2 is not sufficient for this, containers 2 may come to a stop in transfer section 3.3 and, in this case, provision can be made such that containers 2 that have come to rest are pushed through transfer section 3.3 by upstream containers 2, which are still in operative connection with first or second driver 14.1 or 14.2.

In embodiments described herein, transfer section 3.3 can be used as a buffer zone for the storage of containers 2. If containers 2 are to be made available at container outlet 5, for example, on the basis of a corresponding demand signal from a system control, buffered containers 2 can be pushed through transfer section 3.3 until they enter into operative connection with first or second driver 14.1 or 14.2 and can be conveyed to container outlet 5.

Spiral conveyor 1 is preferably operated in such a way that transport section 3.1 and/or 3.2, which is arranged at container outlet 5, is constantly filled with containers 2. In the embodiment shown, this is second transport section 3.2. In order to guarantee that second transport section 3.2 is as completely full as possible at all times, containers 2 can be stored in transfer section 3.3, from which a container 2 is fed into second transport section 3.2 when a container 2 is provided from spiral conveyor 1 at container outlet 5. For example, this can be done by a coordinated operation of first and second drives 20 and 21, wherein containers 2 are pushed by first driver 14.1 through transfer section 3.3, in particular by pushing a row of mutually adjacent containers 2 through transfer section 3.3 and thus making containers 2 available to second driver 14.2.

In a preferred embodiment, the following “division of tasks” results between first drive 20 and second drive 21: The second drive 21, whose task it is to make containers 2 available when a request from a system control is transmitted to spiral conveyor 1, conveys containers 2 to container outlet 5 and makes them available therefrom. To ensure that containers 2 can be made available in a constant cycle or having a standardised distance between one another, first drive 20 ensures in interaction with transfer section 3.3 that second transport section 3.2, to which containers 2 are moved, is as full as possible with containers 2 and that there are no gaps between containers 2. The first drive 20 is able to take over the tasks of the second drive 21 if transport sections 3.1 and 3.2 are arranged differently or are passed through by the containers 2 in the opposite direction.

In addition to first drive 20 and second drive 21, spiral conveyor 1 can comprise a third drive by means of which containers 2 can be moved along transfer section 3.3. For example, the third drive can be designed as a conveyor belt, which extends along transfer section 3.3 and on which containers 2 stand up or are supported thereon when they are transported along transfer section 3.3. Consequently, the third drive can be designed to support the feeding of containers 2 to outlet-side transport section 3.1 and/or 3.2, shown herein as second transport section 3.2.

In addition to spiral conveyor 1, conveyor system 30 comprises a control unit 35. For reasons of clarity, control unit 35 is only shown in FIG. 3. The conveyor system 30 comprises a first sensor device 31 arranged in the area of container inlet 4, which is used to detect a number and direction of movement of containers 2 passing container inlet 4. Sensor device 31 can, for example, be designed as a light barrier, which counts containers 2 which pass the light barrier and determines the direction in which containers 2 pass the light barrier. Sensor device 31 is also designed to transmit a signal to signal interface 36 of control unit 35 of conveyor system 30, which represents the detected number and the detected direction of movement of containers 2 passing container inlet 4. The transmission of the signal can take place via a data transmission channel 37 and may be a wired or wireless connection.

Conveyor system 30 also comprises a second sensor device (not shown). The second sensor device is arranged at container outlet 5 and can be designed, for example, as a light barrier which counts containers 2 which pass the light barrier and which determines the direction in which containers 2 pass the light barrier. The second sensor device is also designed to transmit a signal to signal interface 36 of control unit 35 of conveyor system 30, which represents the detected number and the detected direction of movement of containers 2 passing container outlet 5. The transmission of the signal can take place via a data transmission channel 37 and may be a wired or wireless connection. The total number of containers 2 in conveyor system 30 can be determined by the signals transmitted to control unit 35.

In order to avoid errors and improve operational reliability, conveyor system 30 may also comprises a third sensor device 32, which is also connected to signal interface 36 of control unit 35 in a signal connection. Although a corresponding data transmission channel 37 may be present, such a data transmission channel is not included in FIG. 3 for reasons of clarity. Third sensor device 32 may also be designed as a light barrier and may be arranged, for example, at transfer section 3.3. By means of control unit 35, the signal transmitted by first sensor device 31 and/or the second sensor device can be compared with the signal transmitted by third sensor device 32, so that deviations may be detected, from which conclusions can be drawn as to any malfunction of conveyor system 30.

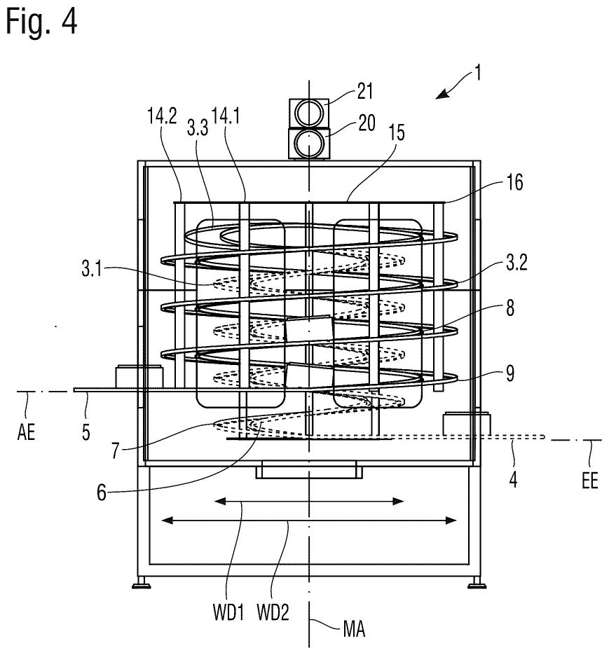

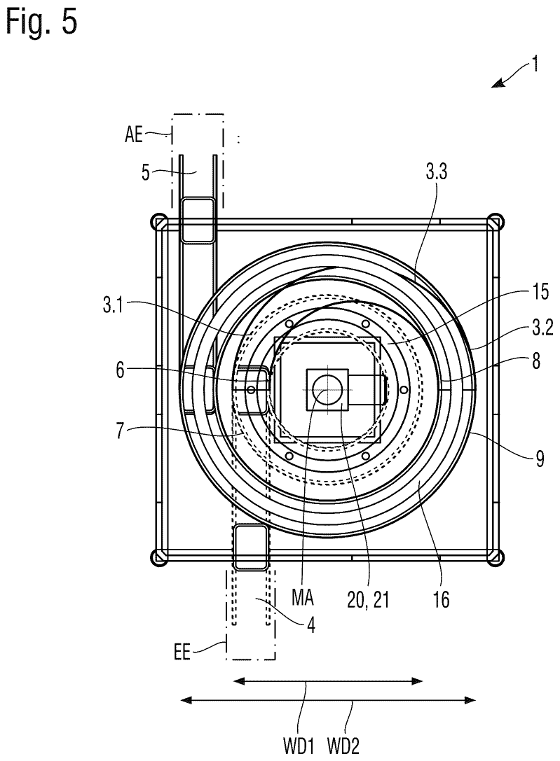

FIGS. 4 and 5 show a second embodiment of a conveyor system 30 with a spiral conveyor 1, which corresponds to a large extent to the first embodiment shown in FIGS. 1 to 3. In order to avoid repetition, a description of the identical components is therefore dispensed with.

The second embodiment of spiral conveyor 1 of conveyor system 30 is characterised in particular by the fact that transfer section 3.3 extends inside a lateral surface of a cylinder bounded by outer container guide 9 of second transport section 3.2. The result is a particularly space-saving configuration of spiral conveyor 1, which can therefore be easily integrated into existing systems.

Transfer section 3.3 extends from the second end of first transport section 3.1 by continuing the curvature of first transport section 3.1. Subsequently, transfer section 3.3 extends with a radius of curvature increasing along the extension of transfer section 3.3 in the form of a 180° curve. The radius of curvature of transfer section 3.3 increases until it corresponds to the radius of the spiral of second transport section 3.2, so that transfer section 3.3 transitions into second transport section 3.2 with a continuous curvature.

As can be seen both from the side view shown in FIG. 4 and the plan view shown in FIG. 5, it is necessary in the second embodiment that first drivers 14.1 and second drivers 14.2 cross transfer section 3.3 in order to be able to move in a circular path around machine axis MA. For this purpose, transfer section 3.3 can be designed as a split version, such that transfer section 3.3 has recesses at the points where drivers 14.1 and 14.2 cross transfer section 3.3.

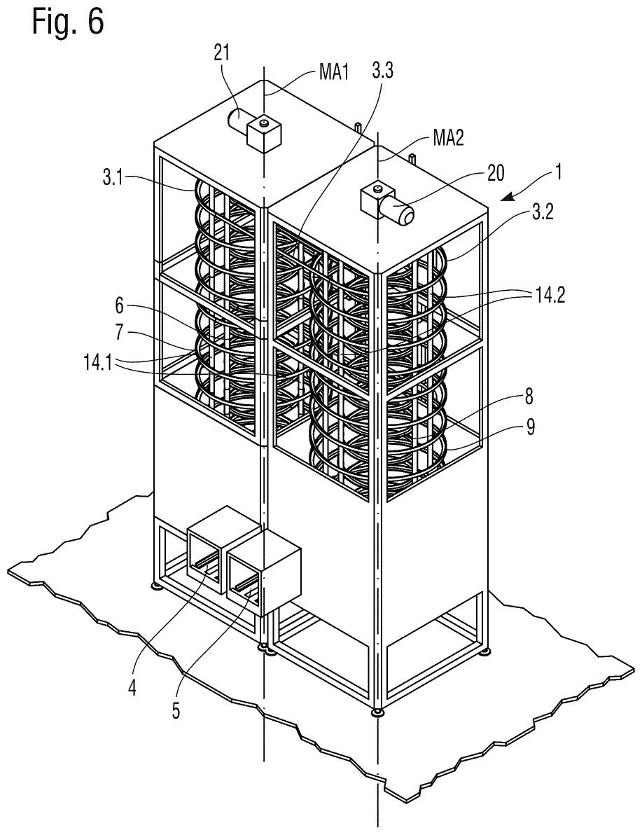

FIG. 6 shows a third embodiment of a conveyor system 30 with a spiral conveyor 1. Spiral conveyor 1 comprises a first transport section 3.1, which winds spirally around a first machine axis MA1. A second machine axis MA2 extends offset laterally from first machine axis MA1, specifically, parallel to and displaced from first machine axis MA1. A second transport section 3.2 is wound in the form of a spiral around second machine axis MA2.

The distance between first machine axis MA1 and second machine axis MA2 is predetermined by first spiral diameter WD1 and second spiral diameter WD2. To ensure that outer container guide 7 of first transport section 3.1 does not overlap with outer container guide 9 of second transport section 3.2, i.e. in order to prevent first transport section 3.1, as viewed in plan view, from projecting into second transport section 3.2 and vice versa, the distance of first machine axis MA1 from second machine axis MA2 is greater than the sum of half of first spiral diameter WD1 and half of second spiral diameter WD2. In other words, the distance between first machine axis MA1 and second machine axis MA2 is greater than the sum of the radii of first transport section 3.1 and second transport section 3.2.

The transfer section 3.3 arranged between first transport section 3.1 and second transport section 3.2 can be designed without restrictions in the embodiment shown. However, it is advantageous to design transfer section 3.3 in a straight line, because this is accompanied by a particularly low production effort and thus low manufacturing costs. It further contributes to a low production effort that first transport section 3.1 can be designed in a mirror-symmetrical manner, or as a mirror image of and symmetrical to second transport section 3.2, if transfer section 3.3 is designed and arranged correspondingly. In particular, first transport section 3.1 can have an identical spiral diameter WD1 than that of second transport section 3.2. Through the adjacent arrangement of first and second transport sections 3.1 and 3.2, moreover, the interior of respective transport sections 3.1 and 3.2 is also easily accessible, so that equipment or devices can be installed, maintained, and replaced therein without excessive effort.

The explanations made above for first drive 20, second drive 21, and the third drive can be transferred to the embodiment shown in FIG. 6. In particular, the spaced arrangement of transport sections 3.1 and 3.2 offers a great deal of design freedom in the selection of drives 20 and 21.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A conveyor system comprising:
a spiral conveyor for conveying containers along a transport section extending between a container inlet arranged in an inlet plane and a container outlet arranged in an outlet plane, wherein the transport section comprises at least:
a first transport section encircling a first machine axis in a helical manner, wherein the first transport section has a first spiral diameter, and the first transport section has a first end and a second end opposite the first end,
a second transport section encircling a second machine axis in a helical manner, wherein the second transport section has a second spiral diameter, and the second transport section has a first end and a second end opposite the first end,
wherein the second machine axis is aligned essentially parallel with the first machine axis,
a transfer section, wherein the transfer section extends between the first transport section and the second transport section,
at least a first driver, wherein the first driver can be brought into operative connection with containers arranged on the first transport section;
at least a second driver, wherein the second driver can be brought into operative connection with containers arranged on the second transport section,
wherein the first transport section has at least one inner container guide extending relative to the first machine axis and at least one outer container guide extending relative to the first machine axis,
wherein the second transport section has at least one inner container guide extending relative to the second machine axis and at least one outer container guide extending relative to the second machine axis,
wherein the first driver penetrates the first transport section between the respective container guides, and the second driver penetrates the second transport section between the respective container guides,
at least one first drive for conveying containers along the first transport section, wherein the first driver is designed to be driveable by means of the first drive, and
at least a second drive for conveying containers along the second transport section, wherein the second driver is designed to be driveable by means of the second drive,
wherein the first drive and the second drive can be operated independently of each other;
a first sensor device arranged in an area of the container inlet, wherein the first sensor device is designed to detect a number and a direction of movement of the containers passing the container inlet and send an inlet signal, wherein the inlet signal represents the detected number and the detected direction of movement of the containers passing the container inlet;
a second sensor device arranged in an area of the container outlet, wherein the second sensor device is designed to detect a number and a direction of movement of the containers passing the container outlet and send an outlet signal, wherein the outlet signal represents the detected number and the detected direction of movement of the containers passing the container outlet; and
a control unit comprising a signal interface,
wherein the first sensor device and the second sensor device are in signal connection with the signal interface, and the control unit is designed to control the first drive and the second drive independently of one another, based on the inlet signal transmitted by the first sensor device and the outlet signal transmitted by the second sensor device and based on a demand signal transmitted by a system control.

2. The conveyor system according to claim 1, wherein the first machine axis is parallel to and shifted with respect to the second machine axis in such a way that a distance between the first machine axis and the second machine axis is at least equal to a sum of half the first spiral diameter of the first transport section and half the second spiral diameter of the second transport section.

3. The conveyor system according to claim 1, wherein the first machine axis and the second machine axis form a common machine axis, wherein the first spiral diameter is smaller than the second spiral diameter so that the first transport section and the second transport section are arranged offset from each other in a radial direction in relation to the common machine axis.

4. The conveyor system according to claim 3, wherein the at least one outer container guide of the first transport section corresponds to the at least one inner container guide of the second transport section.

5. The conveyor system according to claim 3, wherein the transfer section extends relative to the common machine axis radially inside of a lateral surface of a cylinder defined by the at least one outer container guide of the second transport section.

6. The conveyor system according to claim 3, wherein the transfer section extends relative to the common machine axis at least partially radially outside of a lateral surface of a cylinder defined by the at least one outer container guide of the second transport section.

7. The conveyor system according to claim 1, wherein the transfer section extends at least partially in a radial direction relative to one or both of the first machine axis and the second machine axis.

8. The conveyor system according to claim 1, wherein the transfer section extends relative to one or both of the first machine axis and the second machine axis, and extends spaced apart from the inlet plane and the outlet plane and positioned above the inlet plane and the outlet plane.

9. The conveyor system according to claim 1, wherein the first transport section and the second transport section are orientated such that the transfer section is arranged between the second end of the first transport section and the first end of the second transport section such that the direction of movement of the containers that can be arranged on the transport section along the first transport section relative to a longitudinal direction of the first machine axis is opposite to the direction of movement of the containers that can be arranged on the transport section along the second transport section.

10. The conveyor system according to claim 1, wherein one or both of the first machine and the second machine axes or a common machine axis is designed perpendicular to one or both of the inlet plane and the outlet plane.

11. The conveyor system according to claim 1, wherein the first transport section and the second transport section have equivalent spiral gradients.

12. The conveyor system according to claim 1, wherein the conveyor system comprises at least a third sensor device, which is designed to verify the number and direction of movement of the containers detected by one or both of the first sensor device and the second sensor device.

13. The conveyor system according to claim 12, wherein the third sensor device is arranged in an area of the transfer section.
